(19) United States
(12) Patent Application Publication
(10) Pub. No.: US 2007/0268115 A1
(43) Pub. Date: Nov. 22, 2007

(54) Device for disciplining children

(75) Inventor: Robert Douglas Holmes, Devon (GB)

Correspondence Address: CONNOLLY BOVE LODGE & HUTZ, LLP, P O BOX 2207, WILMINGTON, DE, 19899, US

(73) Assignee: Gro-Group International Limited, Devon (GB)

(21) Appl. No.: 11/520,902

(22) Filed: Sep. 14, 2006

(30) Foreign Application Priority Data
May 20, 2006 (GB) 0610127.3

(51) Int. Cl. G08B 1/00

(52) U.S. Cl. 340/309.3

(57) ABSTRACT

A time out device for disciplining a child has (i) a flexible sheet, (ii) a sensor for detecting and signaling whether the child is on the sheet, and (iii) a control section. The control section has a timer, control means for operating the timer in response to signals received from the sensor, input means by which a user may input or select a desired duration for a time out period and signaling means for indicating to a user when a desired time out period has elapsed.

### FIELD OF THE INVENTION

This invention relates to a device for use in disciplining children, in particular for use in requiring a child to take “time out”.

### BACKGROUND TO THE INVENTION

Young children, especially toddlers, need to learn when their behaviour falls short of what adults expect. A common technique for teaching children when they are not behaving well is the “time out” principle, sometimes involving the use of a “naughty step”, “naughty chair”, “naughty corner” or the like. This technique involves banishing the child to a chair, a room, the bottom step of the stairs or some other suitable place away from distractions, for a short number of minutes, to give them time to calm down and reflect on their inappropriate behaviour. The general rule is to ask a child to sit quietly for 1 minute per year in age, so that a 2 year old child would be asked to sit for 2 minutes, a 3 year old for 3 minutes and so on.

Difficulties can arise however in timing this “time out” period, in particular if the child disobeys and leaves the specified place before the end of the stipulated period.

The time out technique can also be difficult to administer in locations outside of the home or nursery where it is usually used, for instance when visiting friends or relatives or on trips out, car journeys and the like—here the usual “naughty chair”, “naughty step” or “naughty room” is unavailable and time out can be more difficult to impose.

A number of children's seats for use in administering “time out” are known from the patent literature, for example U.S. Pat. No. 5,683,137 and U.S. Pat. No. 4,538,142. These tend to be relatively cumbersome, and are unlikely to be easily portable or simple in operation. Other known devices and systems for use in administering the time out technique do not provide a fixed location to which the child has to retire—see for example US-2005/249048 (child's time-keeping device), U.S. Pat. No. 5,684,758 (a countdown timer provided on a toy) and WO-2004/023433 (behaviour shaping kit and method, utilising stickers to indicate “no-go” areas)—and can therefore be more difficult to enforce.

Embodiments of the present invention seek to overcome or at least mitigate the above described problems.

### STATEMENTS OF THE INVENTION

According to a first aspect of the present invention there is provided a device for use in providing a time out period for a child, the device having (i) a flexible sheet, (ii) a sensor for detecting and signaling whether a child is on the sheet and (iii) a control section, the control section having a timer, control means for operating the timer in response to signals received from the sensor, optionally input means by which a user may input or select a desired duration for a time out period and signaling means for indicating to a user when a desired time out period has elapsed.

The invention effectively provides a portable “naughty seat”, which can be easily transported and can be put to use in a range of different locations, according to requirements. The flexible sheet provides a seat which can be opened out prior to use, for instance on the seat of a chair, on a step or even on the floor, and yet which can be easily stowed away for storage or transportation.

Ideally the device is so configured that the flexible sheet may be rolled or folded up around the control section (ie, the control section is at least partly enclosed by the rolled or folded sheet), thus affording protection for potentially sensitive parts of the device during storage and transportation. Fastening means such as a clip, zip, Velcro™-type fastener, tie or button may be provided for releasably securing the sheet in a rolled or folded configuration.

The flexible sheet may be made of any suitable flexible material(s), in particular a plastics material such as a polyurethane. Its dimensions are suitably such as to accommodate a small child sitting on the opened out sheet. It may be elongate in shape (ie, its length is greater than its width). For example, its length may be from 20 to 100 cm, its width from 10 to 100 cm. The flexible sheet may be from 3 mm to 15 mm.

The sensor suitably comprises a pressure sensor such as a pressure sensitive film or pressure activated pad. Suitable such films may be incorporated within the structure of the flexible sheet or alternatively positioned on either face of the sheet. Other types of pressure sensor, for example based on the movement of a fluid between cavities, may be incorporated into the flexible sheet. The sensor may instead or in addition comprise a movement sensor, positioned so as to be capable of detecting when a child stands up or moves away from the device. More than one appropriately positioned sensor may be used if desired.

The purpose of the sensor is to detect whether a child is seated on the flexible sheet, and to signal accordingly to a user and/or to the control means of the device. In this way, the sensor can function, together with the timer, to ensure an appropriate time out period, taking account where necessary of any periods during which the child is unseated.

The control section of the device may be attached to, or even integrated with, the flexible sheet. It comprises a timer, a control means, a signaling means and optionally an input means.

The timer may be clockwork, or conveniently electrical or electronic in operation. It may include a visible display such as an LED or LCD display, to indicate to a user the duration of the selected time out period and/or the time remaining before the end of the time out period and/or the duration of any interruptions to the time out period and/or other relevant information. The timer may in particular be or incorporate a countdown timer.

The control means of the device may be an electronic control means such as a microprocessor. It is conveniently programmable. It receives signals from the sensor associated with the flexible sheet and from the timer, and suitably also has input means such as a numeric key pad or dial, by which a user may input into the control means a desired duration of the time out period and/or other relevant information. The control means may be operable to interrupt operation of the timer when the sensor signals that a child is no longer present on the flexible sheet, and suitably to re-start the timer when the child is re-seated, thus ensuring that the desired time out period can be fully completed. The signaling means of the device suitably serves to indicate to a user when a designated time out period begins and expires, and may also indicate the beginning and end of any interruptions to the time out period for instance when a child stands up from the flexible sheet. The signaling means may for example emit an audible and/or a visual signal. This may be designed to appeal to a child using the device, who can then tell how much longer he or she has to remain seated. The signaling means may emit a signal, such as an audible or electronic signal, which is detectable by a user located remote from the device itself—this can assist an adult in monitoring a child's behaviour during the time out period.

In an embodiment of the invention, the signaling means indicates, at least approximately, the amount of time remaining from the designated time out period. It may provide two or more different signals to indicate for example (a) that the designated period is nearing its end (eg, that there is less than a certain amount of time remaining) and (b) that the designated period has ended and the child is free to leave. A third signal may be provided to indicate that the designated time out period is not yet nearing its end. Such signals could for example be visual, such as different coloured lights. They may for instance emulate traffic lights, with a red light indicating the start or middle of the designated time out period, an amber light indicating that the period is nearing its end and a green light indicating the end of the period.

The signaling means may comprise a display (such as a LCD) provided as part of, or associated with, the timer.

The control section of the device may suitably be housed, at least partially, in a protective cover, for instance of a rigid or semi-rigid material such as a plastics material. It may additionally include a housing for batteries to power the control means, timer, input means, signaling means and/or sensor. It may include means for connection to a mains power source.

At least part of the control section of the device, for example the input means and/or the timer, or in particular a master on/off switch, may be child-proofed in an appropriate manner to reduce the risk of a child tampering with the controls. Many such child-proofing systems are known; they may present physical barriers (for instance, covers) against access to the controls, and/or they may be electrical or electronic in nature, for instance making use of PIN numbers to activate key pads.

Part of the control section of the device may be located remotely from the flexible sheet, and/or be controllable using a remote control. For example, the device may have an associated remote control by which an adult user is able to start and stop the timer. Such a remote control may also include a display for indicating to the user information such as the length of time remaining or the occurrence of an interruption.

A device according to the invention may incorporate additional sensors such as in particular noise sensors, for instance to detect and signal when the noise level in the vicinity of the device exceeds a predetermined limit. This may be used to stop the timer when a child screams or shouts, and to re-start the timer when the child has calmed down sufficiently.

According to a second aspect of the present invention, there is provided a flexible sheet for use as part of a device according to the first aspect, the flexible sheet having an associated sensor for detecting and signaling whether a child is on the sheet. The sheet may include connection means for connecting it to a control section of a device according to the invention, in such a way as to allow signals from the sensor to reach the control means of the device.

A third aspect provides a control section for use as part of a device according to the first aspect of the invention. Again the control section may include connection means for connecting it to a sensor associated with a flexible sheet, in order to assemble a device according to the invention.

The sheet and the sensor of the second aspect of the invention, and the control section of the third, may each independently constitute means, relating to an essential element of the present invention, for putting the first aspect of the invention into effect.

Preferred features of the second and third aspects of the invention may be as described above in connection with the first aspect.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Other features of the present invention will become apparent from the following example. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith.

Moreover unless stated otherwise, any feature disclosed herein may be replaced by an alternative feature serving the same or a similar purpose.

The present invention will now be described by way of example only and with reference to the accompanying illustrative drawings, of which:

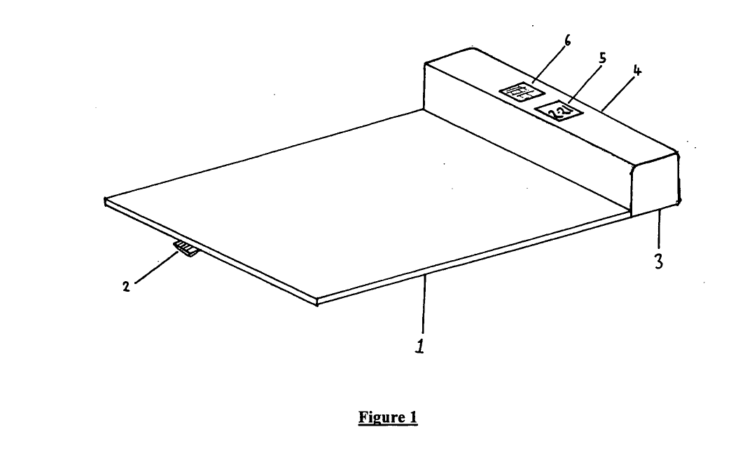

FIG. 1 is a schematic perspective view of a device according to the invention; and

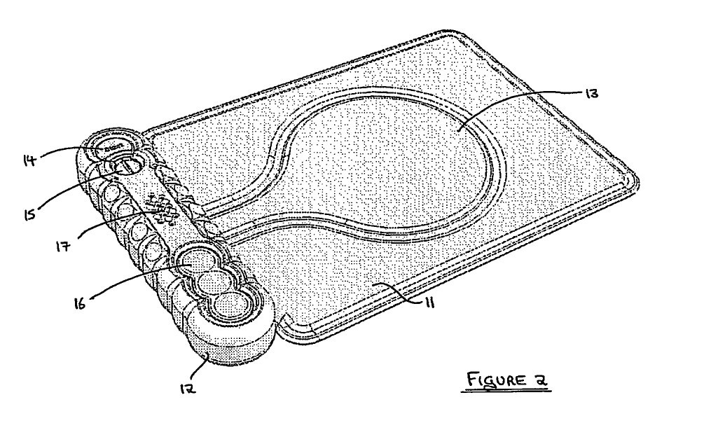

FIG. 2 is a schematic perspective view of an alternative device according to the invention.

### DETAILED DESCRIPTION

The time out device shown in FIG. 1 comprises a flexible plastics sheet 1, for instance made from a strong polyurethane, which is approximately 30 cm long, 20 cm wide and 0.5 cm deep.

At one end, the sheet has a clip 2 by which it can be secured in a rolled up configuration when necessary.

At the opposite end of the sheet, the device has an attached control section 3 which in this case comprises a box made from a rigid plastics material. This houses a countdown timer and other necessary controls, electrical and electronic connections and signaling means, as well as a housing for batteries. A child-proof lid 4 may be provided on the box 3 to ensure that a child cannot tamper with the controls, in particular to alter the selected time out period or otherwise affect operation of the timer. This lid can be lifted to reveal an on/off switch, controls to start and stop the timer and an input means by which an adult user may select a desired time out duration.

A visual display 5, such as a LCD, is provided in the lid 4. This shows the amount of time left on the timer before the selected time out period expires. Such a display may be used to provide any other relevant information to a user of the device.

Also provided in the lid 4 is an integrated speaker 6, through which appropriate sounds can be transmitted to a user, for instance signaling the start or end of, and/or an interruption to, the desired time out period.

The control box may have rounded edges, to prevent injury to users and damage to property, for example if a child misuses the device during a temper tantrum. The rounded edges may be further softened by the addition of over-moulded rubber or a similar thermoplastic elastomer such as Santoprene™. Ideally the box is made from a resilient material which will effectively “bounce” on impact rather than breaking.

Inside the flexible sheet 1 there is incorporated a pressure sensitive electronic film or pad (not shown), which detects whether or not a child is sitting on the sheet and signals accordingly to a programmed circuit board contained within the control section 3. This in turn can start or stop operation of the timer. Instead or in addition, one or more (for instance, one or two) movement sensors may be incorporated into the side of the control section 3, so as to detect if a child stands up or moves away from the sheet.

The device shown in FIG. 1 can be operated as follows.

Firstly, the flexible sheet 1 is unrolled from around the control box 3, onto a suitable surface such as a chair or step or a corner of the floor. An adult user can then open the child-proof lid 4 and switch on the device via a concealed or otherwise protected on/off switch. The adult then selects, by means of a key pad or dial inside the box 3, an appropriate duration for the time out period, for instance a number of minutes from say 1 to 6—this is the period for which the timer is set to count down.

A child is then seated on the flexible sheet, which is detected by the pressure sensitive film, in turn starting the countdown timer. At this point, an audible signal such as a simple beep sound may be emitted from the speaker 6. If the child gets off the sheet during the countdown, a different audible signal (for example a regular beep—beep—beep sound) may be produced, alerting the adult that the child has stood up. When the child sits down again the audible signal ends and the countdown either continues or (depending on the mode of operation, as explained below) re-sets back to the originally selected time out duration.

Once the countdown is completed, again an audible signal may be produced (for example, in this case, a ten second tune), to let both the child and the adult know that the time out session is at an end.

Any suitable audible signal may be emitted by a device according to the invention, for example a trumpet fanfare or a simple beep. Alternatively the start and/or end of the time out period may be signaled purely visually or in some other detectable manner.

Instead or in addition, a device according to the invention may provide visual or any other detectable signals, to an adult and/or a child user, regarding the remaining duration of the designated time out period and/or any interruptions. By way of example, lights or other visual signs may be used to indicate when a time out period starts, ends and/or is interrupted—lights simulating traffic lights may for instance indicate (as in the FIG. 2 device) when a child should remain seated (red), when the time out period is nearing its end (amber) and when the child may leave (green).

In the FIG. 1 device, an adult user may select one of two modes of operation, again using controls concealed under the child-proof cover 4. According to the first mode of operation, once the timer is started, if the child gets up off the sheet 1 before the countdown has finished, the timer will re-set back to the full originally selected time out duration. For example, if at any point the child interrupts a 3 minute countdown, the timer will re-set to 3 minutes.

According to the second mode of operation, if the child stands up off the flexible sheet, the timer will pause at whatever point it has reached and will not re-start the countdown until the child sits back down on the sheet.

After use, the adult turns off the power and the flexible sheet 1 can then be rolled up around the control box 3. The roll can be secured using the clip 2, which is an interlocking clip located at the centre of the free end of the sheet. The device can now readily be stored and transported; it is therefore easy to use even in locations away from the home or nursery. Moreover when not in use, the control section 3 can be protected by the sheet 1 rolled around it.

The alternative device shown in FIG. 2 comprises a flexible foam mat 11, for instance made of a neoprene™ foam, PVC and/or EVA, and an attached control section 12 protected by a hard plastics casing such as of polypropylene (ideally with over-moulded rubber or a similar elastomeric compound).

The mat incorporates a pressure sensor (not seen) which is built into the foam. The region shown generally at 13 is the area in which a child is intended to sit during a time out period, and may be marked out in any appropriate manner, for instance using a foam insert of a different colour to the rest of the mat, or with a printed image. If the child leaves the mat the pressure sensor will signal accordingly to the control section of the device.

The control section includes an on/off button 14, and a mechanical dial 15 by which the user can select the duration of the time out period. By way of a signaling means, the device has three lights, together labelled 16, which are designed to emulate a set of traffic lights. A red light is activated when the time out period begins, to indicate that the child must remain seated on the mat. Sixty seconds before the end of the time out period (or thirty seconds before if a period of only one minute is selected), an amber light is activated to indicate that the child will soon be free to move. Finally, at the end of the period, a green light is activated to indicate that the child has completed the designated punishment and may now leave.

An audible signal may also accompany the end of the time out period, for instance a piece of music, an animal noise or some other sound designed to appeal to, and reward, the child. The device may also emit an audible signal when the device is first switched on, for example a few seconds of music to indicate that the device is ready for a child to sit on. A loudspeaker 17 is provided in the control section for this purpose.

The time selector dial 15 may incorporate a child-proof mechanism. For example, a tough mechanical clicking mechanism may be included, that only allows the dial to turn when a coin is engaged in a slot at the top of the dial, or that otherwise prevents the dial from being turned by fingers alone. The controls may also be so designed that once the countdown has been initiated, manipulation of the dial cannot influence the originally selected time period nor interfere with the countdown timer.

A further function may be provided, which switches off power to the device if at any point during the countdown the on/off button 14 is pressed and held down. An audible signal may be emitted at this point (different to that emitted at the end of a properly completed time out period) to alert an adult user that the device is being switched off. The control means may be arranged to allow this to happen only if the mat 11 is unoccupied, to prevent a child from sitting on the mat and then turning off the timer.

In other respects, operation of the FIG. 2 device is analogous to operation of the FIG. 1 version. Again, the device emits an audible signal if the child stands up from the mat 11 and thus interrupts the time out countdown.

1. A device for use in providing a time out period for a child, the device having (i) a flexible sheet, (ii) a sensor for detecting and signaling whether the child is on the sheet and (iii) a control section, the control section having a timer, control means for operating the timer in response to signals received from the sensor, input means by which a user may input or select a desired duration for a time out period and signaling means for indicating to the user when a desired time out period has elapsed.

2. A device according to claim 1, which is configured so that the flexible sheet may be rolled or folded up around the control section.

3. A device according to claim 2, comprising fastening means for releasably securing the flexible sheet in a rolled or folded configuration.

4. A device according to claim 1, wherein the flexible sheet is made of a plastics material.

5. A device according to claim 1, wherein the flexible sheet is elongate in shape.

6. A device according to claim 1, wherein the sensor comprises a pressure sensor.

7. A device according to claim 6, wherein the pressure sensor is incorporated within the structure of the flexible sheet.

8. A device according to claim 1, wherein the sensor comprises a movement sensor.

9. A device according to claim 1, wherein the control section is attached to the flexible sheet.

10. A device according to claim 1, wherein the timer is electrical or electronic in operation.

11. A device according to claim 1, wherein the timer includes a visible display.

12. A device according to claim 1, wherein the timer incorporates a countdown timer.

13. A device according to claim 1, wherein the control means is electronic in operation.

14. A device according to claim 1, wherein the control means is programmable.

15. A device according to claim 1, wherein the input means comprises a key pad.

16. A device according to claim 1, wherein the input means comprises a dial.

17. A device according to claim 1, wherein the control means is operable to interrupt operation of the timer when the sensor signals that a child is no longer present on the flexible sheet.

18. A device according to claim 17, wherein the control means is operable to re-start the timer when the child is re-seated.

19. A device according to claim 1, wherein the signaling means serves to indicate to a user when a designated time out period begins and expires.

20. A device according to claim 1, wherein the signaling means serves to indicate the beginning and end of any interruptions to the time out period.

21. A device according to claim 1, wherein the signaling means is capable of emitting an audible signal.

22. A device according to claim 1, wherein the signaling means is capable of emitting a visual signal.

23. A device according to claim 1, wherein the signaling means is capable of emitting a signal which is detectable by a user located remote from the device.

24. A device according to claim 1, wherein the signaling means comprises a display provided as part of, or associated with, the timer.

25. A device according to claim 1, wherein the signaling means is capable of emitting a signal to indicate that there is less than a predetermined amount of time remaining from the designated time out period.

26. A device according to claim 1, wherein the signaling means includes two or more different coloured lights.

27. A device according to claim 26, wherein the signaling means includes three different coloured lights to emulate traffic lights.

28. A device according to claim 1, wherein the control section is housed, at least partially, in a protective cover.

29. A device according to claim 1, wherein the control section includes a housing for batteries to power the control means, timer, input means, signaling means and/or sensor.

30. A device according to claim 1, wherein the control section includes means for connection to a mains power source.

31. A device according to claim 1, wherein at least part of the control section is child-proofed.

32. A device according to claim 1, wherein at least part of the control section is located remotely from the flexible sheet.

33. A device according to claim 1, wherein at least part of the control section is controllable using a remote control.

34. A device according to claim 1, which incorporates one or more noise sensors.

35. (canceled)

36. A flexible sheet for use as part of a device according to claim 1, the flexible sheet having an associated sensor for detecting and signaling whether a child is on the sheet.

37. A flexible sheet according to claim 36, which includes connection means for connecting said flexible sheet to a control section of the device in such a way as to allow signals from the sensor to reach the control means of the device.

38. A control section for use as part of a device according to.

39. A control section according to claim 38, which includes connection means for connecting it to a sensor associated with a flexible sheet, in order to assemble a device according to.
